(19) United States
(12) Patent Application Publication
(10) Pub. No.: US 2026/0162181 A1
(43) Pub. Date: Jun. 11, 2026

(54) Methods and Systems for Creating and Managing Commitments for Indian Tribes

(71) Applicants: Donald Hunter, West Hartford, CT (US); William Coons, West Hartford, CT (US)

(72) Inventors: Donald Hunter, West Hartford, CT (US); William Coons, West Hartford, CT (US)

(21) Appl. No.: 18/976,075

(22) Filed: Dec. 10, 2024

(51) Int. Cl. G06Q 40/06; G06Q 40/02

(52) U.S. Cl. CPC G06Q 40/06; G06Q 40/02

(57) ABSTRACT

The present disclosure relates to one or more methods and systems related to executing interactions between a user and a depositary entity. For example, a method may include receiving, via one or more processors for a depositary entity and from a custodian, confirmation of deposit of a share of a Section 17 corporation into an account maintained by the custodian, receiving, via the computer processor and from a user, a request to obtain a depositary receipt associated with the share of the Section 17 corporation, generating, via the computer processor and responsive to the request to obtain a depositary receipt, a depositary receipt, storing, via the computer processor, the depositary receipt in a database maintained by the depositary entity, providing, via the computer processor and to the user, an indication of the generated depositary receipt.

### BACKGROUND OF THE INVENTION

Attraction and formation of capital is a critical factor for ongoing success of any corporation, especially new corporations. Indian tribes in the United States have traditionally struggled to attract capital due to credit worthiness, questionable debt collectability, unsatisfactory debt enforcement, and sovereign status of the tribe that prevents debt enforcement from going through U.S. courts. Equity investment is not generally an option for raising capital for an Indian corporation since most corporate charters associated with Indian tribes do not allow for non-tribal equity investments. Furthermore, each tribe has its own laws and Indian corporations are subject to the laws and courts of the particular tribe under which it is formed. Investors generally desire predictability with their investments, and investing in corporations subject to tribal laws is anything but uniform and predictable. For example, tribes often lack a stable tribal government, have unique laws, have short two-year election cycles, and operate under different tribal constitutions. Additionally, it is unclear how the IRS would rule regarding certain forms of asset management products causing investors to be wary of investment with Indian-owned corporations due to the possible tax implications.

The United States recognizes the sovereign status of federally recognized Indian tribes as domestic dependent nations, which can govern themselves with little oversight or intervention from the federal or state governments. Approximately 56.2 million acres over 326 distinct Indian land areas are held in trust by the United States for various Indian tribes and individuals. Such land areas in the U.S. are administered as federal Indian reservations (i.e., reservations, pueblos, rancherias, missions, villages, communities, etc.). The total land area of Indian reservation land is approximately 2.3% of the total area of the United States, which is about equal to the size of the state of Idaho. Accordingly, there is a large potential for investment in Indian reservations and tribes which has largely been unexplored.

Depositary Receipts (DRs) are negotiable financial instruments that generally provide domestic investors with a means to invest in foreign companies not traded on domestic exchanges of the investor. DRs are most often issued by financial institutions and may be redeemed for shares of the underlying foreign business entities they represent. DRs are often valued in U.S. dollars while the underlying shares of the foreign business entity may be valued in a foreign currency.

Depositary Receipts may be traded in the United States on U.S. stock exchanges. DRs were first introduced in the U.S. in the 1920's in order to streamline the process of investing in business entities not traded on a U.S. exchange. DRs may represent investment in non-U.S. business entities, and, as with other types of DRs, the underlying shares of these non-U.S. businesses. The stock of the underlying non-U.S. businesses is traded on a non-U.S. stock exchange while the DRs themselves trade on a U.S. exchange.

### BRIEF SUMMARY OF THE INVENTION

A system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions. One general aspect includes a computer-implemented method of executing an interaction between a user and a depositary entity. The computer-implemented method also includes receiving, via one or more processors for a depositary entity and from a custodian, confirmation of deposit of a share of a Section 17 corporation into an account maintained by the custodian. The method also includes receiving, via the computer processor and from a user, a request to obtain a depositary receipt associated with the share of the Section 17 corporation. The method also includes generating, via the computer processor and responsive to the request to obtain a depositary receipt, a depositary receipt. The method also includes storing, via the computer processor, the depositary receipt in a database maintained by the depositary entity. The method also includes providing, via the computer processor and to the user, an indication of the generated depositary receipt. Other embodiments of this aspect include corresponding computer systems, apparatus, and computer programs recorded on one or more computer storage devices, each configured to perform the actions of the methods.

One general aspect includes a system that includes at least one processor. The system also includes at least one non-transitory computer-readable storage medium storing instructions thereon that, when executed by the at least one processor, cause the system to: receive, for a depositary entity and from a custodian, confirmation of deposit of a share of a Section 17 corporation into an account maintained by the custodian; receive, from a user, a request to obtain a depositary receipt associated with the share of the Section 17 corporation; generate, responsive to the request, a depositary receipt; store the depositary receipt in a database maintained by the depositary entity; provide, to the user, an indication of the generated depositary receipt. Other embodiments of this aspect include corresponding computer systems, apparatus, and computer programs recorded on one or more computer storage devices, each configured to perform the actions of the methods.

Another general aspect includes a non-transitory computer-readable medium storing instructions thereon that. The non-transitory computer-readable medium storing instructions also includes receiving, for a depositary entity and from a custodian, confirmation of deposit of a share of a Section 17 corporation into an account maintained by the custodian. The instructions also include receiving, from a user, a request to obtain a depositary receipt associated with the share of the Section 17 corporation. The instructions also include generating, responsive to the request, a depositary receipt. The instructions also include storing the depositary receipt in a database maintained by the depositary entity. The instructions also include providing, to the user, an indication of the generated depositary receipt. Other embodiments of this aspect include corresponding computer systems, apparatus, and computer programs recorded on one or more computer storage devices, each configured to perform the actions of the methods.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a process used by entities to generate and maintain depositary receipts (DRs).

FIG. 2 is a block diagram depicting a structure for creation and management of commitments to Indian tribes in the form of an Indian depositary receipt.

FIG. 3 is a block diagram depicting a structure and process for creating and managing commitments to an Indian tribe in the form of an Indian depositary receipt, in accordance with one or more embodiments.

FIG. 4 is a flowchart depicting a method of executing an interaction between a user and a depositary entity, according to one or more embodiments of the present disclosure.

FIG. 5 illustrates a representative system that provides a suitable operating environment for use with some embodiments of the described systems and method.

FIGS. 6 and 7 each illustrate a representative networked environment for use with some embodiments of the described systems and methods.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

The Indian Reorganization Act (IRA) of 1934, also known as the Wheeler-Howard Act, was a significant piece of legislation that aimed to reverse the policy of allotment and assimilation of Native American lands and cultures. Section 17 of the IRA allowed Indian tribes to form corporations for various purposes, including economic development, land management, and tribal self-governance. Under Section 17, tribes may organize corporations to engage in various economic activities, such as managing tribal resources, businesses, and natural assets, and land management. While separate and distinct from tribal government, a Section 17 corporation is wholly owned by the tribe and enjoys the same federal income tax-exempt status as the tribe. If the Section 17 corporation defaults on the payment of funds it has borrowed, only the corporation's property and assets are at risk.

The present disclosure incorporates a type of depositary receipt (DR) structure and process which utilizes Indian Section 17 corporations combined with a traditional US investment market product (e.g., a DR) and its associated processes to create an “Indian Depositary Receipt” (IDR), which allows US domestic investors to utilize the special constitutionally derived income tax status of Native American tribes and their associated Section 17 corporations, as sovereign entities.

This unique process and structure, combined with the tax-exempt attributes of a Section 17 corporation, and managed by a professional manager may provide above average returns to the investors, not available in any other way. The present disclosure also provides a mechanism for corporations associated with Indian tribes to receive outside investment and grow in ways that are currently limited. In some ways, the mechanism, processes, and structures disclosed herein allow more autonomy for Section 17 corporations that may help prevent political instability in the tribe to affect the Section 17 corporation and its corporate governance. Furthermore, the funds received in exchange for the IDRs may be used in accordance with limitations from the corporate charter of the Section 17 corporation. The IDR may also provide a unique social benefit to the tribal owner of the Section 17 corporation, providing critical funds that may be used for tribal governance, health, education, and welfare of tribal members.

Furthermore, because the present disclosure enables a user to obtain, within a single system, a depositary receipt that is associated with a Section 17 corporation that uses US dollars as its currency, the present disclosure is advantageous over conventional depositary receipt systems which require currency exchange. For instance, because the IDR system of the present disclosure enables a user to obtain a depositary receipt without needing to convert foreign currencies to US currency at any point, the IDR system reduces required processing power, memory, and communication resources needed to facilitate obtaining depositary receipts. Accordingly, the IDR system results in less data transfer and data bandwidth usage for a computer/communication system. In other words, the IDR system results in less required processing power and communication bandwidth in comparison to conventional systems. As a result, the IDR system of the present disclosure, in comparison to conventional systems, may be in some cases a more appropriate system for mobile devices. Additionally, in view of the foregoing, the IDR system may result in more user friendly, consistent, attractive, and convenient forms of investment in Indian tribes through associated Section 17 corporations in comparison to investment in foreign companies.

Furthermore, because the IDR system allows for additional commitments to Indian tribes, the IDR system of the present disclosure improves conventional Indian investment systems because a greater number of commitments and investments may be communicated over a network by one or more clients connected to the network and to a server connected to the network.

In some embodiments, securitization of a Section 17 corporation may be facilitated through the issuance of DRs. Securitization refers to a process where a pool of assets, such as equity, loans, or mortgages, are bundled together and sold to investors as securities. Depositary receipts represent ownership in the underlying assets or securities and are typically issued by a depositary bank. One advantage of the present disclosure is integration of certain securitization techniques with depositary receipt mechanisms to enhance liquidity and accessibility for investors in Indian-owned corporations that have historically struggled to obtain financing. By securitizing assets and issuing depositary receipts backed by these securitized assets, issuers may effectively tap into broader investor markets, diversify risk, enhance technological access to Indian-owned assets, and streamline the process of asset-backed securities trading.

In another aspect, the present disclosure may facilitate the creation of depositary receipt programs tailored to specific asset classes, allowing for efficient securitization across diverse industries. This involves structuring the depositary receipts in accordance with the characteristics of the underlying assets, such as cash flows, maturity profiles, and risk profiles. Additionally, the method encompasses the establishment of robust regulatory frameworks and operational protocols to ensure compliance and transparency throughout the securitization process. By providing a standardized framework for securitization via depositary receipts, this disclosure may help to foster confidence among investors and facilitate the seamless transfer of asset-backed securities in the U.S. or even the global financial marketplace.

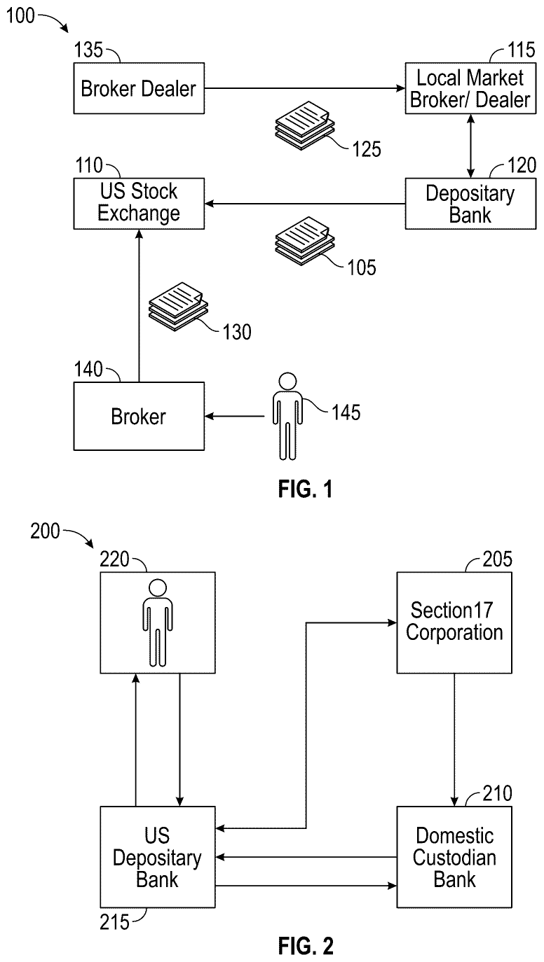

FIG. 1 illustrates a structure 100 used by entities to generate and maintain DRs 105. Two financial institutions are generally involved in maintaining DRs 105 on a U.S. stock exchange 110: broker/dealer 115 and a depositary bank 120. The broker/dealer 115 purchases the underlying shares 125 of the Indian business entity and offers them for sale in the U.S. The depositary bank 120 handles the issuance and cancellation of DR certificates 105, backed by the underlying shares held by the investment bank, based on orders 130 placed by investors 145 through brokers 140.

The underlying shares 125 of the Indian business entity and the DRs 105 themselves are generally valued in U.S. dollars. Based on a determined DR ratio, each DR 105 may be issued as representing one or more of a fraction of the underlying shares 125 and the price of each DR 105 will be reflected in the currency in which it is traded.

To issue a DR 105, the broker/dealer 115 arranges to buy the shares of the Indian business entity via broker dealer 135 so that the broker/dealer 115 may have the DRs 105 issued on the U.S. stock exchange 140. Accordingly, the DRs 105 may be considered to be repackaged shares, backed by the actual Indian business entity shares 125, but owned by a beneficial owner of the DR investor.

The continual buying and selling of both DRs 105 and the underlying shares 125 on the U.S. stock exchange 110 and via broker dealer 135 works to maintain the prices of the DR 105 and the underlying shares 125 in close parity with one another. Because of this close parity, most DRs 125 are traded by means of intra-market trading.

When a DR 105 is traded, a broker 140 works to find the best price of the underlying shares 125 in question. The broker 140 compares the price of the DR 105 with the price of the underlying share 125 in the home country market 135. If the DR 105 of the underlying share 125 is trading higher than the corresponding quantity of underlying shares 125, a broker 140 may buy more of the underlying shares 125 and issue DRs 105 on the U.S. market. This action would then, in theory, cause the price of the underlying shares 125 and the price of the DR 105 to reach parity. Therefore, the price of the DRs 105 floats on supply and demand. If the price of the DR 105 is significantly different from the price of the underlying shares 125 of the Indian business entity, then an arbitrage opportunity may exist, which is then corrected by the participation of arbitrage investors, who take advantage of the spread and eliminate the opportunity.

A broker 140 may also sell DRs 105 back via broker dealer 135. This is known as cross-border trading. When this trading occurs, a quantity of DRs 105 is canceled by the depositary bank 120 and a corresponding quantity of the underlying shares 125 are released from the broker/dealer 115.

Types of conventional Depositary Receipts (DRs) may include American Depositary Receipts (ADRs), Global Depositary Receipts (GDRs), European Depositary Receipts (EDRs), and International Depositary Receipts. DRs may be traded on a U.S. stock exchange, such as the New York Stock Exchange (NYSE) or the America Stock Exchange (ASE). GDRs are commonly listed on European stock exchanges such as the London Stock Exchange. Both DRs and GDRs are usually denominated in U.S. dollars, but may also be denominated in euros or other national currencies.

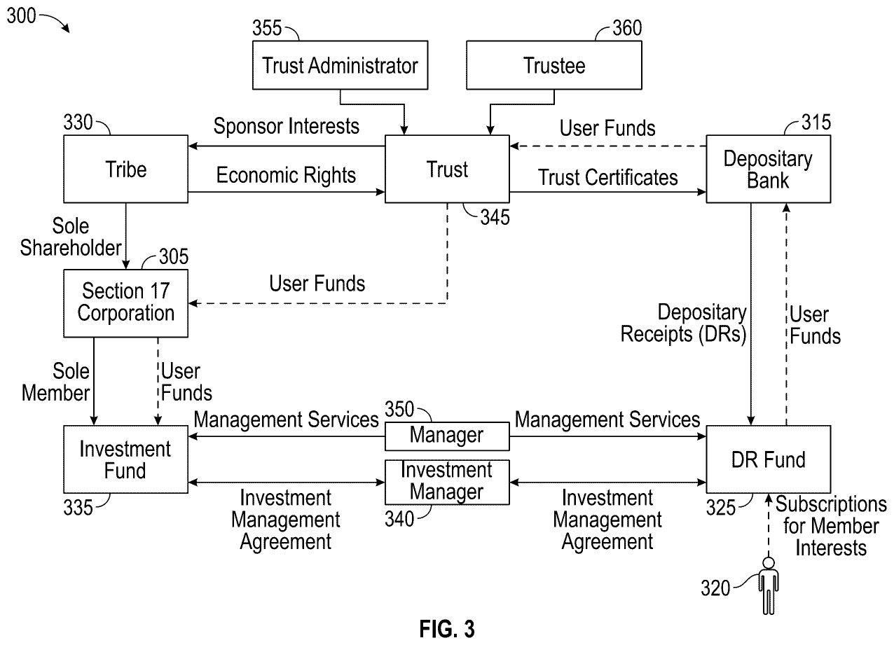

FIG. 2 is a block diagram depicting a structure 200 for creation and management of commitments to Indian tribes in the form of an IDR. A corporate charter for Section 17 corporation 205 may be issued by the Department of the Interior to an Indian tribe. Section 17 corporation 205 may be a non-tax-paying entity due to its tax-exempt status under the IRA. In some embodiments, Section 17 corporation 205 may issue ordinary shares of stock equity. In some cases, such shares may be limited to ownership by tribal members only. Shares issued by Section 17 corporation 205 may be held in deposits by domestic custodian bank 210. In some instances, domestic custodian bank 205 may not sell more than 50% of the equity of Section 17 corporation 205 or the corporation's status under Section 17 may be jeopardized.

Depositary bank 215 may issue depositary receipts against the shares, which may be purchased and/or owned by user 220. In some embodiments, American user 220 does not have any direct relationship with custodian bank 210 or Section 17 corporation 205. Custodian bank 210 may inform and/or update depositary bank 215 regarding share prices of Section 17 corporation 205. Depositary Bank 215 may communicate with custodian bank 210 regarding underlying assets such as shares of Section 17 corporation 205. For example, depositary bank 215 may receive updates regarding the price or value of the shares of Section 17 corporation 205, or updates regarding new issuance of shares of Section 17 corporation 205.

User 220 may desire to invest in Section 17 corporation 205, which is associated with a particular Indian tribe. User 220 may send a message, in some cases via a handheld device or a computer, to depositary bank 215 requesting to purchase one or more depositary receipts issued by depositary bank 215. Depositary bank 215 may communicate with custodian bank 210 to retrieve a share price for Section 17 corporation 205. In some cases, depositary bank 215 may communicate directly with Section 17 corporation 205 to retrieve an equity share price. Custodian bank 210 may respond to depositary bank 215 with a share price for shares held in deposit at custodian bank 210 of Section 17 corporation 205. Depositary bank 215 may then issue a depositary receipt against one or more shares of Section 17 corporation 205 held in deposit at custodian bank 210 to user 220. Via this process, user 220 may effectively invest in Section 17 corporation 205 by purchasing depositary receipts from depositary bank 215 that are tied to shares held in deposit by custodian bank 210.

In some embodiments, information presented by depositary bank 215 may be presented to user 220 over the internet or other network. In some embodiments, user 220 may access a website or application maintained by depositary bank 215 in order to purchase one or more depositary receipts backed by one or more shares of Section 17 corporation 205 held in deposit at custodian bank 210. Depositary bank 215 may present a dynamically changing graphical user interface (GUI) to user 220 via the application or website over the internet and user 220 may interact directly with the application or website using a handheld or computer device. In this manner, user 220 may be provided remote access to automatically updated information about depositary receipts related to shares of Section 17 corporation 205. In some embodiments, user 220 may be required to register with depositary bank 215 and maintain a current account that requires authentication to access. For example, user 220 may be required to enter a username and password any time user 220 desires to view or modify account details, sell, buy, or otherwise transfer depositary receipts held in deposit at depositary bank 215.

In some embodiments, depositary bank 215 may receive updates from custodian bank 210 or from Section 17 corporation 205 regarding a price of underlying shares of Section 17 corporation 205. Such updates may be provided on a regular (e.g., automatic) basis from custodian bank 210 or Section 17 corporation 205, or in some cases, depositary bank 215 may query custodian bank 210 or Section 17 corporation 205 for updates. Updates may be provided on any timetable that is standard in the industry, and in some examples may be provided weekly, daily, hourly, every minute, every second, or more often. In some embodiments, depositary bank 215 may automatically provide such updates to user 220. For example, depositary bank 215 may provide daily or weekly updates on the price of the depositary receipt, which may be similar or identical to the price of the underlying shares of Section 17 corporation 205. In some embodiments, one or more thresholds may be set such that depositary bank 215 sends an automatic update to user 220 when a change in the price of the depositary receipt changes by more than the threshold amount, whether a positive or negative change. In some embodiments, the threshold may be different for positive or for negative changes. In another example, an automatic update may be sent to user 220 when a price is lower or higher than a predefined threshold. Another threshold may be a number of trades executed in a certain period of time (e.g., every week, day, or hour), where an automatic update may be sent to user 220 if the number of trades exceeds the threshold amount for the period of time. Updates may be provided to user 220 via any standard method of automatic notification including email, text message (e.g., SMS or other chat message), push notification, etc. In some embodiments, shares of Section 17 corporation 205 may be mapped or indexed to the depositary receipts stored in depositary bank 215 (e.g., via electronic means over a network) such that any changes in share price are directly and automatically reflected in the price of the depositary receipts.

In some embodiments, depositary bank 215 may convert information received from custodian bank 210 and/or Section 17 corporation 205 into a different format to be presented to user 220. For example, information received may be simplified such that a layperson could understand the meaning of the information without undue effort. Or for example, information may be compressed and condensed and presented in a graphically pleasing manner (e.g., via a GUI) that is visually easier to understand for user 220.

In some embodiments, there may be more than one user 220, and the methods and systems described herein may be applied to scenarios where more than one user 220 desires to or has purchased a depositary receipt from depositary bank 215 backed by shares of Section 17 corporation 205. In some embodiments, one or more shares of Section 17 corporation 205 may be bundled together and sold as a single DR. In some embodiments, one or more shares of multiple Section 17 corporations (e.g., from different Indian tribes) may be bundled together and sold as a single asset, such as a DR.

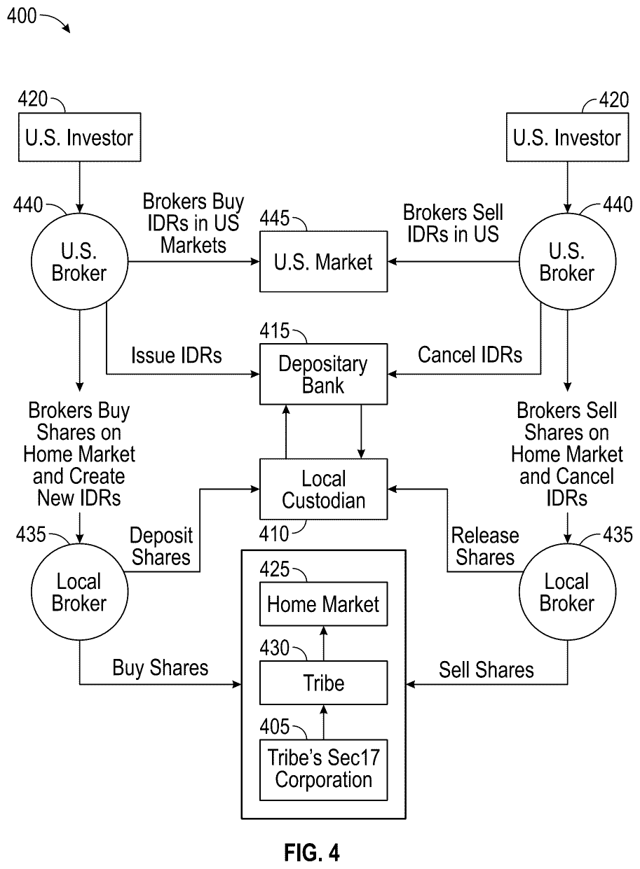

FIG. 3 is a block diagram depicting a structure 300 and process for creating and managing commitments to an Indian tribe in the form of an IDR, in accordance with one or more embodiments. Structure 300 may be an example embodiment of structure 100 of FIG. 1 or structure 200 of FIG. 2, with variations and/or additional details. However, one of ordinary skill in the art will recognize that each of structure 100, 200, and 300 may be compatible with each other. In FIG. 3, dotted arrows indicate contractual payment obligations between the various indicated parties in structure 300. The actual flow of funds may be modified by the parties pursuant to a participation agreement, such that (i) with respect to subscriptions, funds may be delivered from DR fund 325 to investment fund 335, and (ii) with respect to redemptions, funds may be delivered from investment fund 335 to DR fund 325.

Tribe 330 may be an example of any federally recognized Indian tribe that may legally form a Section 17 corporation under the IRA. In structure 300, tribe 330 may form Section 17 corporation 305, with the assistance of the Department of the Interior. Section 17 corporation 305 may issue a single share of stock which is owned by tribe 330, and may be represented by several DRs issued by depositary bank 315. In other embodiments, Section 17 corporation 305 may issue multiple shares of stock that may be represented by a corresponding number of DRs issued by depositary bank 315.

Section 17 corporation 305 may create a state-registered company, such as a limited liability company (LLC) (e.g., investment fund 335). Section 17 corporation 305 may be the sole member of the investment fund 335 LLC. Investment fund 335 may be managed by an independent investment manager 340. Investment manager 340 may be any kind of company manager and is not limited to managing investments. A relationship between investment manager 340 and both investment fund 335 and DR fund 325 may be governed by one or more investment management agreements. In some embodiments, additional management services may be provided by a third-party manager 350.

Tribe 330 may create a statutory trust 345 which is configured to issue trust certificates that represent any beneficial interests in tribe 330 or Section 16 corporation 305. Tribe 330 may contribute all economic rights with respect to the sole share of stock issued by Section 17 corporation 305 to trust 345. Trust 345 may be administered by trust administrator 355 and legal title the trust assets may be held in the name of trustee 360. Tribe 330 may be a sponsor of trust 345 and received a “sponsor's interest” in trust 345. The sponsor interest does not entitle tribe 330 to receive any income or assets while trust certificates are outstanding. Despite maintaining voting rights, tribe 330 may agree not to exercise those voting rights to the detriment of the holders of trust certificates.

Depositary bank 315 may issue depositary receipts (DRs) to DR fund 325 for cash. Depositary bank 315 may exchange the investor funds with trust 345 for trust certificates that entitle the holder to undivided beneficial interest in the assets and income of trust 345. The interest of user 320 in the trust certificates is evidenced by user's ownership of the DRs. User funds may be transferred by trust 345 to Section 17 corporation 305, whereupon Section 17 corporation 305 may transfer user funds to investment fund 335.

In some embodiments, DR fund 325 may be an example of any kind of fund that allows a user 320 to invest or subscribe in a particular fund, such as DR fund 325. For example, DR fund 325 may be a mutual fund or an index fund, wherein user 320 may purchase shares of DR fund 325, in some cases via a broker, including an online brokerage. Accordingly, user 320 may access DR fund 325 via a user device (not shown) that has access to the Internet. User 320 may provide funds to DR fund, which may in turn, deposit the user funds in depositary bank 315 in exchange for one or more DRs. Depositary bank 315 may provide deposited user funds to trust 345, which may in turn provide the user funds to Section 17 corporation 305, of which tribe 330 is the sole shareholder. Therefore, user funds provided by user 320 may directly benefit tribe 330, which may use the funds for any purpose that tribe 330 sees fit, including tribal self-government, building infrastructure, providing education and other basic needs for tribal members. Furthermore, any return on the commitment (e.g., investment) from user 320 may be tax-exempt since the underlying investment itself is in a tax-exempt organization, i.e., Section 17 corporation 305. In some cases, the return on the commitment from user 320 is tax-deferred instead of tax-exempt. The IDRs may be valued at a discounted cash-flow on a tax-equivalent rate basis. In other words, the value of the IDRs (or the underlying Section 17 corporation shares) may reflect a tax-equivalent rate. Furthermore, valuing IDRs may be less complex than valuing a standard DR since there is no foreign currency fluctuations to account for.

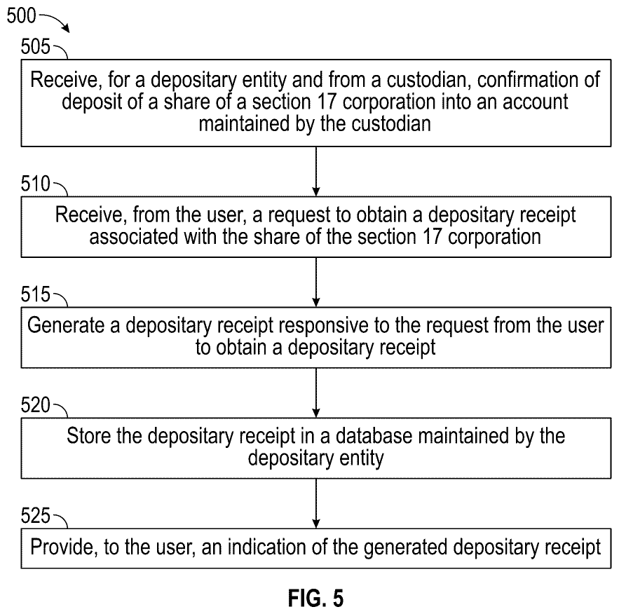

FIG. 4 is a block diagram depicting a structure 400 and process for creating and managing commitments to an Indian tribe in the form of an IDR, in accordance with one or more embodiments. Structure 400 may be an example embodiment of structure 100 of FIG. 1, structure 200 of FIG. 2, or structure 300 of FIG. 3, with variations and/or additional details. However, one of ordinary skill in the art will recognize that each of structure 100, 200, and 300 may be compatible with each other.

At the center of structure 400, depositary bank 415 may communicate with local custodian 410 to exchange information related to one or more IDRs that are stored in depositary bank 415 and/or one or more shares of Section 17 corporation 405. In some embodiments, local custodian 410 may be a trust, and in some cases may be a Delaware trust. Section 17 corporation 405 may be associated with tribe 430 and may make one or more shares of Section 17 corporation 405 available on a local or home market 425. The home market 425 may include many tribal corporations associated with tribe 430. For example, tribe 430 may have set up multiple Section 17 corporations to represent various industries and business interests with which tribe 430 is involved. In some cases, tribe 430 may be associated with multiple Section 17 corporations, each specializing in a different industry, such as construction, agriculture, management, technology, product sales, services, etc.

Local broker 435 may be a broker or dealer that specializes in buying, selling, and trading shares of Indian corporations such as Section 17 corporation 405. Local broker 435 may buy or sell shares of one or more Section 17 corporations 405 via home market 425. Local broker 435 may then deposit or release shares of Section 17 corporation 405 with local custodian 410. Depositary bank 415 may be notified that shares of Section 17 corporation 405 have been deposited or released with local custodian 410.

U.S. broker 440 may be a any broker that sells or buys DRs (e.g., IDRs) on a U.S. market 445 (e.g., NYSE, ASE, or Nasdaq stock market). U.S. broker 440 may issue or cancel IDRs that are stored at depositary bank 415. U.S. broker 440 may buy and/or sell IDRs on U.S. market 445. U.S. investor 420 may work through U.S. broker 440 to buy and sell IDRs on U.S. market 445. In some embodiments, U.S. broker 440 buys and sells shares on home market 425 via local broker 435 and in this manner may create and/or cancel IDRs. In some embodiments, U.S. broker 440, or in some cases depositary bank 415, may create a platform that allows for investment in Section 17 corporations across various Indian reservations and associated with different Indian tribes. Such a uniform platform may allow for scaling of investments in Indian tribes that has not previously been possible or plausible. The different variables that exist within the various tribes may be uniformly adapted to sell a single IDR (or a plurality of IDRs) that funnels funds to the tribes in greater amounts. The platform may be a particular software (e.g., a web-based) program that allows for investment in IDRs or it may be integrated into existing investment software and/or web-based programs.

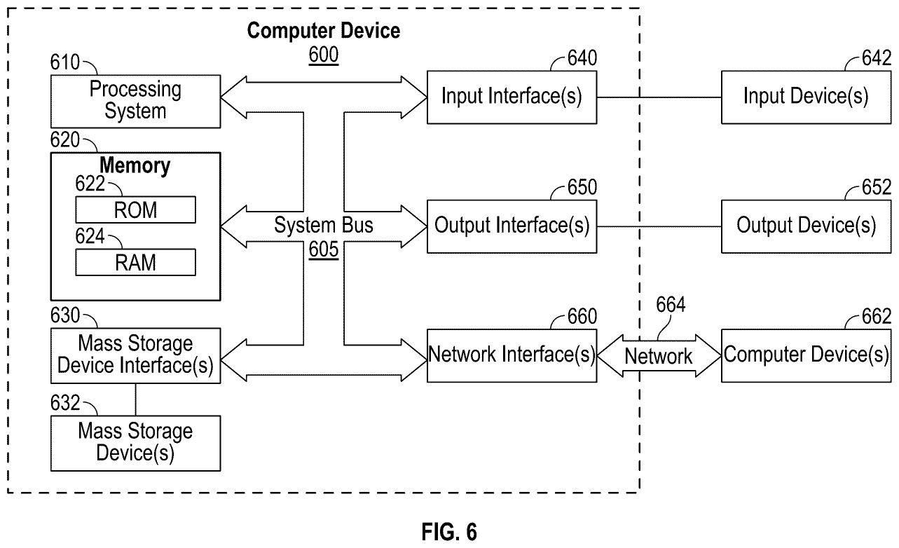

FIG. 5 is a flowchart depicting a method 500 of executing an interaction between a user and a depositary entity, according to one or more embodiments of the present disclosure. One or more operations shown in FIG. 5 may be performed by one or more processors, in accordance with embodiments of the present disclosure. At operation 505, the method 500 may include receiving, for a depositary and from a custodian, confirmation of deposit of a share of a Section 17 corporation into an account maintained by the custodian. At operation 510, the method 500 may include receiving, from the user, a request to obtain a depositary receipt associated with the share of the Section 17 corporation. At operation 515, the method 500 may include generating a depositary receipt responsive to the request from the user to obtain a depositary receipt. At operation 520, the method 500 may include storing the depositary receipt in a database maintained by the depositary entity. At operation 525, the method 500 may include providing, to the user, an indication of the generated depositary receipt.

The indication may include an electronic event such as a message, notification, update, alert, or change in status within a digital environment. The disclosed system that performs method 500 may include a plurality of electronic devices interconnected via a communication network, wherein each device is configured to detect and generate indications of electronic events relevant to one or more users. Upon detection of such events, the system may employ a notification mechanism to transmit the indication to the user in a timely and user-friendly manner. The notification may include visual cues such as on-screen pop-up notifications, audible alerts, tactile feedback, or any combination thereof, tailored to the user's preferences and accessibility needs. Additionally, the system may incorporate intelligent algorithms to prioritize and customize delivery of notifications based on factors such as the user's activity level, historical interaction patterns, or contextual relevance of the event. By providing efficient and personalized notification of electronic events, the disclosed system enhances user engagement, productivity, and overall user experience within the digital environment.

In some embodiments, the method 500 may include additional operations that are not shown in FIG. 5. For example, the method 500 may include operations such as receiving, from the user, an inquiry regarding a value of the depositary receipt, providing, to the custodian, a request to retrieve a value of the share of the Section 17 corporation, and receiving, from the custodian, an indication of a current value of the share of the Section 17 corporation. The method 500 may also include operations such as receiving, from the custodian, an updated value of the share of the Section 17 corporation, updating the value of the depositary receipt stored in the database to reflect the updated value of the share of the Section 17 corporation, and providing, to the user, the updated value of the depositary receipt. In some embodiments, the updated value of the depositary receipt substantially matches the updated value of the Section 17 corporation.

In some embodiments, the Section 17 corporation referenced in method 500 may deposit the share of the Section 17 corporation into the account maintained by the custodian. In one or more embodiments, generating a depositary receipt responsive to the request to obtain a depositary receipt includes generating a plurality of depositary receipts for a single share of the Section 17 corporation, while in other embodiments, the number of depositary receipts corresponds to the number of shares of the Section 17 corporation held in deposit by the custodian.

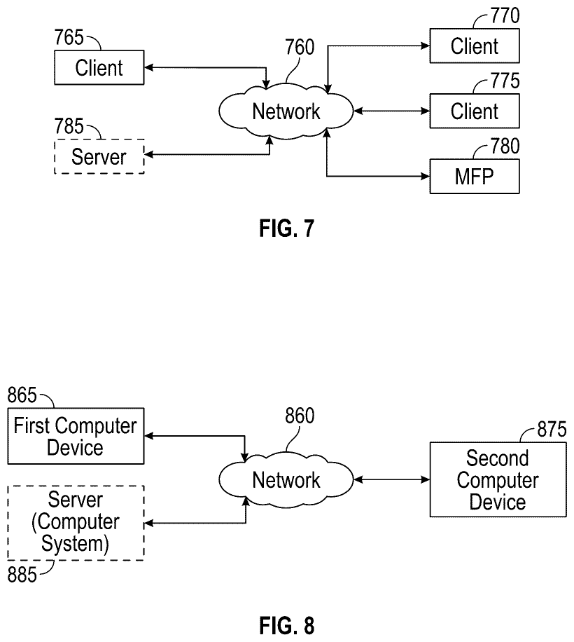

The described systems and methods can be used with any suitable operating environment and/or software. In this regard, FIG. 6 and the corresponding discussion are intended to provide a general description of a suitable operating environment in accordance with some embodiments of the described systems and methods. As will be further discussed below, some embodiments embrace the use of one or more processing units in a variety of customizable enterprise configurations, including in a networked or combination configuration, which may also include a cloud-based service, such as a platform as a service, software as a service, and/or as any other suitable service.

Some embodiments of the described systems and methods embrace one or more computer readable media, wherein each medium may be configured to include or includes thereon data (non-transitory or transitory) or computer executable instructions for manipulating data. The computer executable instructions include data structures, objects, programs, routines, and/or other program modules that may be accessed by one or more processors, such as one associated with a general-purpose modular processing unit capable of performing various different functions and/or one associated with a special-purpose modular processing unit capable of performing a limited number of, and/or specific, functions.

Computer executable instructions cause the one or more processors of the one or more enterprises to perform a particular function or group of functions and are examples of program code means for implementing steps for methods of processing. Furthermore, a particular sequence of the executable instructions provides an example of corresponding acts that may be used to implement such steps.

Examples of computer readable media (including, without limitation, non-transitory computer readable media) include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), any solid state storage device (e.g., flash memory, smart media, etc.), and/or any other device or component that is capable of providing data and/or executable instructions that may be accessed by a processing unit.

With reference to FIG. 6, a representative enterprise includes modular processing unit 600 (e.g., a computer system, a wireless computer device, and/or other computer device), which may be used as a general-purpose or a special-purpose processing unit. For example, modular processing unit (or computer device) 600 may be employed alone or with one or more similar modular processing units as a smart phone, a cellular phone, a feature phone, a tablet computer, a smart television, a mobile computer device, a personal computer, a notebook computer, a PDA or other hand-held device, a workstation, a minicomputer, a mainframe, a supercomputer, a multi-processor system, a network computer, a processor-based consumer device, a smart appliance or device, a control system, and/or the like. Indeed, in some embodiments, the modular processing unit 600 comprises at least one of a server and a computer device (including, without limitation, a wireless computer device). Using multiple processing units in the same enterprise provides increased processing capabilities. For example, each processing unit of an enterprise can be dedicated to a particular task or can jointly participate in distributed processing.

In FIG. 6, the modular processing unit 600 (e.g., a computer system and/or computer device) includes one or more buses and/or interconnects 605, which may be configured to connect various components thereof and enables data to be exchanged between two or more components. The bus(es)/interconnect(s) 605 may include one of a variety of bus structures, including, without limitation, a memory bus, a peripheral bus, and/or a local bus that uses any of a variety of bus architectures. Typical components connected by the bus(es)/interconnect(s) 605 include one or more processors 610 and one or more memories 620. Some other non-limiting components that may be selectively connected to the bus(es)/interconnect(s) 605 through the use of logic, one or more systems, and one or more subsystems, include one or more mass storage device interfaces 630, input interfaces 640, output interfaces 650, and/or network interfaces 660, each of which will be discussed below.

In some embodiments, the processing system 610 includes one or more processors, such as a central processor, a microprocessor, and optionally one or more other processors designed to perform a particular function or task. It is typically the processing system 610 (also referred to as a processor or computer processor) that executes the instructions provided on computer readable media, such as on the memory 620, a magnetic hard disk, a removable magnetic disk, a magnetic cassette, an optical disk, and/or from a communication connection, which may also be viewed as a computer readable medium.

In accordance with some embodiments, the memory 620 includes one or more computer readable media (including, without limitation, non-transitory computer readable media) that may be configured to include or includes thereon data or instructions for manipulating data, and may be accessed by the processing system 610 through the system bus 605. The memory 620 may include, for example, ROM 622 used to permanently store information, and/or RAM 624 used to temporarily store information. In some embodiments, ROM 622 includes a basic input/output system (“BIOS”) having one or more routines that are used to establish communication, such as during start-up of computer device 600. In some embodiments, RAM 624 includes one or more program modules, such as one or more operating systems, application programs, and/or program data.

One or more mass storage device interfaces 630 may be used to connect one or more mass storage devices 632 to the system bus 605. The mass storage devices 632 may be incorporated into and/or may be peripheral to the computer device 600 and allow the computer device (and/or computer system) 600 to retain large amounts of data. Optionally, one or more of the mass storage devices 632 may be removable from computer device 600. Examples of mass storage devices include hard disk drives, magnetic disk drives, tape drives, solid state mass storage, and/or optical disk drives.

Some non-limiting examples of solid state mass storage include flash cards and memory sticks. The mass storage device 632 may read from and/or write to a magnetic hard disk, a removable magnetic disk, a magnetic cassette, an optical disk, or another computer readable medium. The mass storage devices 632 and their corresponding computer readable media provide nonvolatile storage of data and/or executable instructions that may include one or more program modules, such as an operating system, one or more application programs (or applications), other program modules, or program data. Such executable instructions are examples of program code means for implementing steps for methods disclosed herein.

One or more input interfaces 640 may be employed to enable a user to enter data (e.g., initial information) and/or instructions to computer device (or computer system) 600 through one or more corresponding input devices 642. Examples of such input devices include a keyboard and/or alternate input devices, such as a digital camera, a sensor, bar code scanner, debit/credit card reader, signature and/or writing capture device, pin pad, touch screen, mouse, trackball, light pen, stylus or other pointing device, a microphone, a joystick, a game pad, a scanner, a camcorder, and/or other input devices. Similarly, examples of input interfaces 640 that may be used to connect the input devices 642 to the system bus 605 include a serial port, a parallel port, a game port, a universal serial bus (“USB”), a firewire (IEEE 1394), a wireless receiver, a video adapter, an audio adapter, a parallel port, a wireless transmitter, and/or another interface.

One or more output interfaces 650 may be employed to connect one or more corresponding output devices 652 to the system bus 605. Examples of output devices include one or more monitors, projectors, display screens, speakers, lights, wireless transmitters, printers, and the like. A particular output device 652 may be integrated with or peripheral to computer device 600. Examples of output interfaces include a video adapter, an audio adapter, a parallel port, and the like.

One or more network interfaces 660 enable computer device (or computer system) 600 to exchange information with one or more local or remote computer devices, illustrated as computer devices 662, via a network 664 that may include one or more hardwired and/or wireless links. Examples of the network interfaces include a network adapter for connection to a local area network (“LAN”) or a modem, a wireless link, an infrared link, a BLUETOOTH® link, and/or another adapter for connection to a wide area network (“WAN”), such as the Internet. The network interface 660 may be incorporated with or be peripheral to computer device 600.

In a networked system, accessible program modules or portions thereof may be stored in a remote memory storage device. Furthermore, in a networked system computer device 600 may participate in a distributed computing environment, where functions or tasks are performed by a plurality networked computer devices. While those skilled in the art will appreciate that the described systems and methods may be practiced in networked computing environments with many types of computer system configurations, FIG. 7 represents an embodiment of a portion of the described systems in a networked environment that includes clients (or computer devices 765, 770, 775, etc.) and/or and one or more peripheral devices (illustrated as multifunctional peripheral (MFP) MFP 780) connected to a server 785 via a network 760. While FIG. 7 illustrates an embodiment that includes three clients (e.g., computer devices, such as smart phones and/or other wireless computing devices) connected to the network (and one or more servers 785), alternative embodiments include at least one client connected to a network or many (e.g., 2, 4, 5, 6, 7, 8, and or any other suitable number of) clients connected to a network and/or one or more servers. In some embodiments, client 765 may represent a user device operated by a user such as user 220 of FIG. 2. Other client computer devices may represent depositary bank 215 and custodian bank 210 of FIG. 2. In other embodiments, server device 785 may represent depositary bank 215 or another third-party server device not shown in FIG. 2.

In one non-limiting illustration of a basic view of the described systems, FIG. 8 shows that, in some embodiments, the system comprises two or more computer devices (e.g., 865 and 875) that are connected to a server (or other computer system) 885 through a network 860 (e.g., the Internet and/or any other suitable server). While the computer devices can comprise any suitable computer device (e.g., as described above), including, without limitation, a display comprising (or otherwise in signal communication with a device comprising a) processing unit (e.g., a smart display, a smart TV, etc.), a smart phone, a cell phone, a tablet, a laptop, a desktop computer, and/or any other suitable computer device, in some embodiments, the first computer device comprises a smart phone and the second computer device comprises smart phone and/or a smart display. In some other embodiments, however, at least one computer device (e.g., a first computer device 865) in a transaction comprises a wireless computer device (e.g., a smart phone, cell phone, tablet, laptop, etc.) while at least one other computer device in the transaction (e.g., a second computer device 875) comprises a computer device that is in signal communication with a display (e.g., TV, monitor, projector, screen, and/or other display).

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

1. A computer-implemented method of executing an interaction between a user and a depositary entity, the method comprising:
receiving, via one or more processors for a depositary entity and from a custodian, confirmation of deposit of a share of a Section 17 corporation into an account maintained by the custodian;
receiving, via the one or more processors and from a user, a request to obtain a depositary receipt associated with the share of the Section 17 corporation;
generating, via the one or more processors and responsive to the request to obtain the depositary receipt, the depositary receipt;
storing, via the one or more processors, the depositary receipt in a database maintained by the depositary entity; and
providing, via the one or more processors and to the user, an indication of the generated depositary receipt.

2. The computer-implemented method of claim 1, further comprising:
receiving, via the one or more processors and from the user, an inquiry regarding a value of the depositary receipt;
providing, via the one or more processors and to the custodian, a request to retrieve a value of the share of the Section 17 corporation; and
receiving, via the one or more processors and from the custodian, an indication of a current value of the share of the Section 17 corporation.

3. The computer-implemented method of claim 1, wherein the share of the Section 17 corporation is deposited by the Section 17 corporation into the account maintained by the custodian.

4. The computer-implemented method of claim 1, further comprising:
receiving, via the one or more processors and from the custodian, an updated value of the share of the Section 17 corporation;
updating, via the one or more processors, a value of the depositary receipt stored in the database to reflect the updated value of the share of the Section 17 corporation; and
providing, via the one or more processors and to the user, the updated value of the depositary receipt.

5. The computer-implemented method of claim 4, wherein the updated value of the depositary receipt substantially matches the updated value of the share of the Section 17 corporation.

6. The computer-implemented method of claim 1, wherein generating a depositary receipt responsive to the request comprises generating a plurality of depositary receipts for a single share of the Section corporation that is held in deposit by the custodian.

7. The computer-implemented method of claim 1, wherein a number of depositary receipts corresponds to a number of shares of the Section 17 corporation held in deposit by the custodian.

8. The computer-implemented method of claim 1, wherein the depositary receipt is issued against the share of the Section 17 corporation.

9. The computer-implemented method of claim 1, wherein the Section 17 corporation comprises a single shareholder which is a federally recognized Indian tribe.

10. The method of claim 1, wherein receiving the request from the user comprises receiving a request from the user via a separate fund to which the user is subscribed.

11. The method of claim 1, wherein providing the indication to the user of the generated depositary receipt comprises providing the indication to the user via a separate fund to which the user is subscribed.

12. The method of claim 1, wherein the custodian comprises a trust configured to issue trust certificates representing beneficial interest in the share of the Section 17 corporation.

13. A system comprising:
at least one processor; and
at least one non-transitory computer-readable storage medium storing instructions thereon that, when executed by the at least one processor, cause the system to:
receive, for a depositary entity and from a custodian, confirmation of deposit of a share of a Section 17 corporation into an account maintained by the custodian;
receive, from a user, a request to obtain a depositary receipt associated with the share of the Section 17 corporation;
generate, responsive to the request, a depositary receipt;
store the depositary receipt in a database maintained by the depositary entity; and
provide, to the user, an indication of the generated depositary receipt.

14. The system of claim 13, wherein the at least one non-transitory computer-readable storage medium stores additional instructions thereon that, when executed by the at least one processor, further cause the system to:
receive, from the custodian, an updated value of the share of the Section 17 corporation;
update a value of the depositary receipt stored in the database to reflect the updated value of the share of the Section 17 corporation; and
provide, to the user, the updated value of the depositary receipt.

15. The system of claim 14, wherein the updated value of the depositary receipt substantially matches the updated value of the share of the Section 17 corporation.

16. The system of claim 13, wherein the depositary receipt is issued against the share of the Section corporation.

17. The system of claim 13, wherein the Section 17 corporation comprises a single shareholder which is a federally recognized Indian tribe.

18. A non-transitory computer-readable medium storing instructions thereon that, when executed by at least one processor, cause at least one processor to perform steps comprising:
receiving, for a depositary entity and from a custodian, confirmation of deposit of a share of a Section 17 corporation into an account maintained by the custodian;
receiving, from a user, a request to obtain a depositary receipt associated with the share of the Section 17 corporation;
generating, responsive to the request, a depositary receipt;
storing the depositary receipt in a database maintained by the depositary entity; and
providing, to the user, an indication of the generated depositary receipt.

19. The non-transitory computer-readable medium of claim 18, wherein receiving the request from the user comprises receiving a request from the user via a separate fund to which the user is subscribed.

20. The non-transitory computer-readable medium of claim 18, wherein the custodian comprises a trust configured to issue trust certificates representing beneficial interest in the share of the Section 17 corporation.
